(19) United States
(12) Patent Application Publication
(10) Pub. No.: US 2005/0039449 A1
(43) Pub. Date: Feb. 24, 2005

(54) Power generating apparatus

(75) Inventor: Kunio Hashimoto, Fukuoka (JP)

Correspondence Address: NIXON PEABODY, LLP, 401 9TH STREET, NW, SUITE 900, WASHINGTON, DC, 20004-2128, US

(73) Assignee: NIPPON PIPE CONVEYOR RESEARCH INSTITUTE CO., LTD., Fukuoka-shi (JP)

(21) Appl. No.: 10/774,465

(22) Filed: Feb. 10, 2004

(30) Foreign Application Priority Data
Aug. 22, 2003 (JP) 2003-208396
Aug. 25, 2003 (JP) 2003-208595

(51) Int. Cl. F16D 33/00

(52) U.S. Cl. 60/325

(57) ABSTRACT

An inventive power generating apparatus includes: a rotator 1 in which liquid is enclosed; two or more actuators 3 provided at equal intervals around the periphery of the rotator 1; and a guide rail 41 on which rollers 11 are rolled. A vacuum is produced within a cylinder 7 of at least one of the actuators located at an upper part of the rotator 1 such that a pressure difference between the resulting vacuum pressure and atmospheric pressure acts upon a piston of the actuator 3, and the rollers 11 of the actuator 3 are engaged with the guide rail 41, thus providing torque to the rotator 1.

### BACKGROUND OF THE INVENTION

1. Field of the Invention

The present invention relates to an apparatus for generating power by utilizing a pressure difference between vacuum pressure and atmospheric pressure.

2. Description of the Prior Art

As a power generating apparatus of this type, an apparatus that produces a Torricellian vacuum by utilizing the weight of liquid and atmospheric pressure and that generates power by utilizing a pressure difference between the resulting vacuum pressure and atmospheric pressure is known (e.g., see Japanese Unexamined Patent Publication No. 8-159007 and U.S. Pat. No. 5,671,602).

The apparatus disclosed in these documents includes a plurality of U-shaped actuating tubes. Each actuating tube accommodates liquid such as mercury, and a piston is slidably fitted to an upper end of each actuating tube with airtightness maintained. The plurality of actuating tubes are each connected to a crankshaft, and each actuating tube is raised and tilted with the rotation of the crankshaft. When the actuating tube is raised and substantially vertically oriented, a Torricellian vacuum is produced below the piston due to the weight of the liquid. By utilizing a force for retracting the piston into the actuating tube due to this vacuum, the crankshaft is rotated. With the rotation of the crankshaft, the actuating tube tilts down, and the piston in the tilted down actuating tube is pushed back due to the weight of the liquid. The actuating tube whose piston is pushed back is raised again along with the rotation of the crankshaft, and a Torricellian vacuum is produced again in the actuating tube. As described above, in the apparatus, the raising and tilting of the plurality of actuating tubes is repeated with phase varied, thus continuously rotating the crankshaft.

However, the apparatus disclosed in the above-mentioned documents requires a plurality of actuating tubes and a mechanism for tilting down them with phase varied, and thus presents the problem that the structure of the apparatus is complicated.

Further, the apparatus presents another problem that the center of gravity of the liquid is moved due to the movement thereof in each actuating tube incident to its raising and tilting, and thus the rotation of the crankshaft undesirably gets out of balance; therefore, the apparatus is not yet in actual use even though the prototype thereof has been manufactured over and over again.

### SUMMARY OF THE INVENTION

In view of the above-described problems in the prior art, an object of the present invention is to provide a power generating apparatus that is simple in structure and operating principle, that can be easily implemented, and that achieves cleanliness and cost effectiveness.

An inventive power generating apparatus is an apparatus for generating power utilizing a pressure difference between vacuum pressure and atmospheric pressure. This apparatus includes: a holder; a rotator which is rotatably supported with respect to the holder so as to be rotated in one direction around a horizontal axis, and in which liquid is enclosed; two or more actuators provided at equal intervals around the periphery of the rotator; and a guide rail provided so as to be inclined from its starting end, located above the rotator, to its terminal end located downwardly in a rotational direction of the rotator. Each of the actuators has: a cylinder that is provided at the periphery of the rotator and is communicated with the inside of the rotator; a piston that is inserted into the cylinder and is reciprocated in an axial direction of the cylinder between an upper end point and a lower end point thereof; a piston rod connected to the piston; a roller that is attached to a tip of the piston rod and is rolled on the guide rail; and a locking mechanism for switching each of the actuators between a fixed state in which the piston is fixed at the upper end point so that the reciprocation of the piston is restricted, and a movable state in which the reciprocation of the piston is allowed.

In the apparatus, the liquid is enclosed in the inside of the rotator and that of each cylinder such that a liquid level is formed within the cylinder of at least one of the actuators located at an upper part of the rotator, and a state in which a vacuum is produced above the liquid level within the cylinder is defined as an initial state. Furthermore, the plurality of actuators sequentially repeat: a first step in which the actuator, whose cylinder has a vacuum produced therein, is switched to the movable state by the locking mechanism, and the piston located at the upper end point of the cylinder is retracted into the cylinder utilizing a pressure difference between vacuum pressure and atmospheric pressure; a second step in which the roller of the actuator switched to the movable state is engaged with a part of the guide rail in the vicinity of the starting end thereof; a third step in which due to the engagement of the roller with the guide rail, the cylinder of the actuator is moved relative to the piston, and torque is provided to the rotator; a fourth step in which the relative movement of the cylinder is continued, and with the ensuing rotation of the rotator, the roller is rolled on the guide rail; a fifth step in which upon arrival of the roller at the terminal end of the guide rail, the piston is located at the lower end point of the cylinder, and furthermore, the cylinder is located below the liquid level, thus vanishing the vacuum within the cylinder; a sixth step in which after the roller has left the terminal end of the guide rail, the piston is moved to the upper end point of the cylinder due to the weight of the liquid and the weight of the piston, piston rod and roller; a seventh step in which the actuator, whose piston has moved to the upper end point, is switched to the fixed state by the locking mechanism; and an eighth step in which the actuator switched to the fixed state is moved above the liquid level with the rotation of the rotator, and a vacuum is produced again within the cylinder of the actuator. Thus, the rotator is rotated.

The cylinder of each of the actuators may include: a base portion protruded in a radial direction from the peripheral surface of the rotator; and an actuating portion that is bended at an outer end of the base portion and is extended in the rotational direction of the rotator, and the piston may be reciprocated within the actuating portion.

Besides, the cylinder of each of the actuators may be provided so as to protrude linearly in a radial direction from the peripheral surface of the rotator. In that case, the guide rail is provided so as to be inclined from the starting end, located above the rotator, to the terminal end located downwardly in the rotational direction of the rotator.

The power generating apparatus may further include: an air vent pipe communicated with the cylinder of at least one of the actuators; and a liquid supply pipe provided in the vicinity of the air vent pipe at the peripheral surface of the rotator. In that case, an opened end of the liquid supply pipe is preferably located above that of the air vent pipe when the opened end of the liquid supply pipe is located at a top part of the rotator.

The locking mechanism may have an actuating lever, and the power generating apparatus may further include: unlocking means, provided in the vicinity of the upper part of the rotator, for operating the actuating lever so as to switch the actuator from the fixed state to the movable state; and locking means, provided in the vicinity of a lower part of the rotator, for operating the actuating lever so as to switch the actuator from the movable state to the fixed state. Moreover, the actuating lever may be operated electromagnetically.

The power generating apparatus may further include a starter for providing an initial torque to the rotator. In addition, the power generating apparatus may further include a constant speed device for keeping the rotational speed of the rotator at a constant speed.

A method for fabricating a power generating apparatus such as one described above includes the following steps a) through g). Specifically, the method includes the steps of: a) providing two or more cylinders communicated with the inside of a rotator at equal intervals around the periphery of the rotator; b) attaching a roller to a tip of each piston rod, and connecting the piston rod to each piston; c) inserting each of the pistons into an associated one of the cylinders; d) providing each of the cylinders with a locking mechanism for switching each piston between a fixed state in which the piston is fixed at an upper end point of the cylinder so that the reciprocation of the piston is restricted, and a movable state in which the reciprocation of the piston is allowed; e) allowing the rotator to be rotatably supported with respect to a holder so that the rotator is rotated in one direction around a horizontal axis; f) providing a guide rail inclined from its starting end, located above the rotator, to its terminal end located downwardly in a rotational direction of the rotator; and g) enclosing liquid in the inside of the rotator and that of each cylinder such that a liquid level is formed within the cylinder of at least one of the actuators located at an upper part of the rotator, and producing a vacuum above the liquid level within the cylinder.

In the inventive power generating apparatus, a vacuum is produced within the cylinder of the actuator located at the upper part of the rotator, and the roller of the actuator is engaged with the guide rail, thereby converting a pressure difference between the resulting vacuum pressure and atmospheric pressure into torque for the rotator. This rotational power is generated by utilizing atmospheric pressure as energy and is thus clean energy, so that there is no possibility of environmental pollution whatsoever. Moreover, the inventive apparatus is simple in structure and operating principle and can be easily implemented.

Besides, by providing the air vent pipe and the liquid supply pipe, it becomes possible to easily create the initial state of the apparatus. Specifically, the liquid supply pipe and the air vent pipe are located at the top part of the rotator, and the air vent pipe is opened; then, in this state, the liquid is supplied to the inside of the rotator through the liquid supply pipe. Thus, the inside of the rotator and that of each cylinder can be completely filled with the liquid. Thereafter, the liquid supply pipe and the air vent pipe are hermetically closed, and another liquid supply pipe located at the lower part of the rotator is opened. By discharging the liquid to the outside of the rotator in this manner, a vacuum similar to a Torricellian vacuum can be produced within the cylinder located at the upper part of the rotator. Further, the air vent pipe and the liquid supply pipe can each be communicated with a communicating pipe that is communicated with each cylinder (the liquid supply pipe is also communicated with the rotator). In this case, the air vent pipe and the liquid supply pipe are communicated with each other via the communicating pipe, and the air vent pipe and the liquid supply pipe are both communicated with each cylinder. In the communicating pipe, air trapped in each cylinder is collected.

Furthermore, the unlocking means is provided in the vicinity of the upper part of the rotator, while the locking means is provided in the vicinity of the lower part of the rotator. Thus, with the rotation of the rotator, each actuator can be switched from the fixed state to the movable state in the vicinity of the upper part of the rotator, and can be switched from the movable state to the fixed state in the vicinity of the lower part of the rotator. Accordingly, the above-described first step and seventh step can each be carried out automatically.

In addition, by providing the starter, the operation of the power generating apparatus can be started with certainty, and by providing the constant speed device, the rotational power can be optimized as one for an electric generator; furthermore, it becomes possible to prevent problems, caused by the increase in centrifugal force acting upon each actuator, from occurring.

Accordingly, the inventive power generating apparatus has the potential for the utilization of new energy instead of the utilization of various conventional energies. Moreover, the source of energy for the inventive apparatus is limitless, and thus the inventive apparatus is superior in cost effectiveness. Besides, the energy source ensures stable supply.

### BRIEF DESCRIPTION OF THE DRAWINGS

FIG. 1 a longitudinal cross-sectional view illustrating an embodiment of a power generating apparatus.

FIG. 2 is a transverse cross-sectional view illustrating said one embodiment of the power generating apparatus.

FIG. 3 is a cross-sectional view taken along the line III-III shown in FIG. 1.

FIG. 4 is a cross-sectional view taken along the line IV-IV shown in FIG. 3.

FIG. 5 is an explanatory diagram enlargedly illustrating an unlocking means.

FIG. 6 is an explanatory diagram enlargedly illustrating a locking means.

FIG. 7 is a longitudinal cross-sectional view which illustrates the power generating apparatus formed in the same way as that shown in FIG. 1 and which includes reference characters for calculation.

FIG. 8 is a longitudinal cross-sectional view enlargedly illustrating an upper part of a rotator.

FIG. 9 is a longitudinal cross-sectional view which illustrates the power generating apparatus formed in the same way as that shown in FIG. 1 and which includes reference characters for calculation.

FIG. 10 is a longitudinal cross-sectional view which illustrates the power generating apparatus formed in the same way as that shown in FIG. 1 and which includes reference characters for calculation.

### DESCRIPTION OF THE PREFERRED EMBODIMENTS

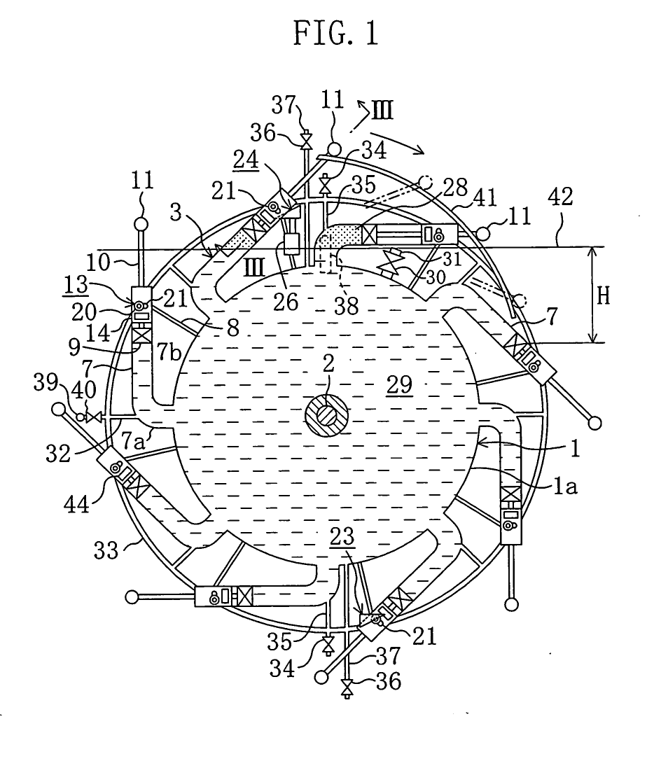

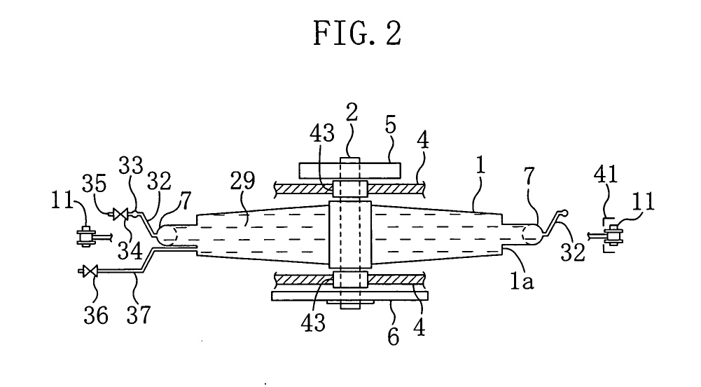

Hereinafter, an embodiment of the present invention will be described with reference to the drawings. FIGS. 1 through 4 illustrates said one embodiment of the present invention.

In the drawings, the reference numeral 1 denotes a rotator in which its central axis is horizontal, and its inside is in an airtight and liquidtight state. Further, a horizontally extending output shaft 2 is penetrated through the center of the rotator 1. The output shaft 2 is supported by a holder 4 via a pair of bearings 43 located in front of and behind the rotator 1 with the rotator 1 sandwiched therebetween, thus allowing the rotator 1 to rotate around the horizontal axis.

The output shaft 2 is provided at its ends with a first gear 5 and a second gear 6 each formed by a spur gear, a chain sprocket, a pulley or the like. The first gear 5 transmits the torque of the output shaft 2 to a driven means (not shown) such as an electric generator, and is connected with a constant speed device (not shown) for keeping the rotational speed of the rotator 1 constant. As the constant speed device, various types can be adopted. On the other hand, the second gear 6 is connected with a starter (not shown) for providing an initial torque at the start of operation of the rotator 1. Between the first gear 5 and the driven means, a clutch for interrupting power transmission may be provided.

Around the periphery of the rotator 1, two or more (in the shown example, eight) actuators are provided at equal intervals. Each actuator 3 includes a cylinder 7, a piston 9, a piston rod 10, rollers 11 and a locking mechanism 13 as will be described later.

At a peripheral surface 1a of the rotator 1, a plurality of (in the shown example, eight) cylinders 7 having mutually identical shapes are provided at equal intervals in a circumferential direction and at equal angles with respect to the peripheral surface 1a. Each cylinder 7 is communicated with the inside of the rotator 1. Each cylinder 7 includes: a base portion 7a extending in a radial direction from the peripheral surface 1a of the rotator 1; and an actuating portion 7b extending in a rotational direction of the rotator 1 from an end of the base portion 7a, and each cylinder 7 is bended so as to be L-shaped as viewed from front. A free end of each actuating portion 7b is supported by an associated one of supporting rods 8 radially extending from the peripheral surface 1a of the rotator 1.

The piston 9 is fitted into the actuating portion 7b of each cylinder 7, and the inside of each cylinder 7 and that of the rotator 1 communicated therewith are each placed into an airtight and liquidtight state. Between an upper end point located at the outermost position in the axial direction of each actuating portion 7b and a lower end point located at the innermost position in the axial direction of each actuating portion 7b, each piston 9 reciprocates in the axial direction.

The pistons 9 are each connected with one end of the associated piston rod 10 that protrudes outward in the axial direction from the actuating portion 7b of each cylinder 7. At the other end of each piston rod 10, a pair of rollers 11, 11 are rotatably supported by a shaft 12 extending in the same longitudinal direction as the output shaft 2.

Provided at the free end of the actuating portion 7b of each cylinder 7 is the locking mechanism 13 for locking the piston 9 and the piston rod 10, with the piston 9 located at the upper end point.

Each of the locking mechanisms 13 includes: a tube body 14 connected to the free end of the actuating portion 7b of each cylinder 7; a pair of rollers 16 provided at an intermediate portion of each piston rod 10; a reversible plate 19 provided at an intermediate portion in the tube body 14; and a pair of pin-shaped actuating levers 21, 22 provided at the peripheral surface of the reversible plate 19 in a protruding condition.

Each tube body 14 is provided at its lower portion with an air vent 44, thus allowing atmospheric pressure to act upon each piston 9.

At the intermediate portion of each piston rod 10, the rollers 16 are rotatably supported by a pair of shafts 15 each provided so as to protrude in a radial direction of the piston rod 10, and the rollers 16 are located above the reversible plate 19 when the piston 9 is located at the upper end point. The rollers 16 are locked by the after-mentioned locking mechanism when they are located above the reversible plate 19.

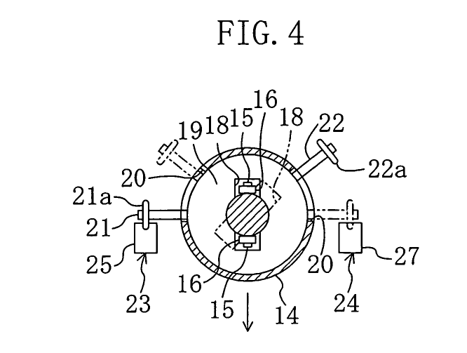

Each reversible plate 19 is supported from both sides thereof by a pair of upper and lower thrust bearings 17, 17 and is thus housed in the tube body 14, so that the reversible plate 19 is reversible around the axis of the tube body 14 and cannot be moved in the axial direction of the tube body 14. Further, as shown in FIG. 4, the reversible plate 19 is provided at its midsection with a drilled passage hole 18, and this passage hole 18 is reversed with the reversal of the reversible plate 19. Hereinafter, the position at which the passage hole 18 is oriented as indicated by the imaginary lines in FIG. 4 will be called “locking position” of the locking mechanism 13, and the position at which the passage hole 18 is oriented as indicated by the solid lines in FIG. 4 will be called “unlocking position” of the locking mechanism 13.

The actuating levers 21, 22 are passing through elongated holes 20 formed at the peripheral surface of the tube body 14, and are protruding outwardly of the tube body 14. As will be described later, by moving these actuating levers 21, 22, the reversible plate 19 is reversed, thus switching the locking mechanism 13 between the locking position and the unlocking position. The actuating levers 21, 22 are preferably provided at their ends with rollers 21a, 22a that rotate around the axes of the actuating levers 21, 22, respectively.

When the locking mechanism 13 assumes the unlocking position indicated by the solid lines in FIG. 4, the shafts 15 and the rollers 16 can pass through the passage hole 18, and the piston rod 10 and the piston 9 can accordingly reciprocate in the axial direction of the actuating portion 7b of the cylinder 7. In other words, this actuator 3 is placed into a movable state.

On the other hand, when the locking mechanism 13 assumes the locking position indicated by the imaginary lines in FIG. 4, the passage hole 18 is deviated from the path taken by the shafts 15 and the rollers 16 when they move, and thus the shafts 15 and the rollers 16 cannot pass through the passage hole 18. Therefore, by positioning the reversible plate 19 at the locking position with the piston 9 located at the upper end point, the piston 9 is prevented from moving to the inner space of the cylinder 7. In other words, this actuator 3 is placed into a fixed state.

The locking mechanism 13 is switched from the unlocking position to the locking position by a locking means 23 that is attached to the holder 4 at a position below the rotator 1. On the other hand, the locking mechanism 13 is switched from the locking position to the unlocking position by an unlocking means 24 that is attached to the holder 4 at a position above the rotator 1.

In the present embodiment, the locking means 23 is formed by an inclined cam 25 having an inclined surface 25a. This inclined cam 25 is fixed to the holder 4 at a position below the rotator 1. The inclined cam 25 is located on the path taken by the locking actuating lever 21 when it moves, and as shown in FIG. 6, the locking actuating lever 21 of the cylinder 7, which has reached a lower part of the rotator 1 with the rotation thereof, abuts against the inclined surface 25a of the inclined cam 25. Thus, the actuating lever 21 moves along the inclined surface 25a with the rotation of the rotator 1, and the reversible plate 19 is reversed with the movement of the actuating lever 21. As a result, the locking mechanism 13 is switched to the locking position.

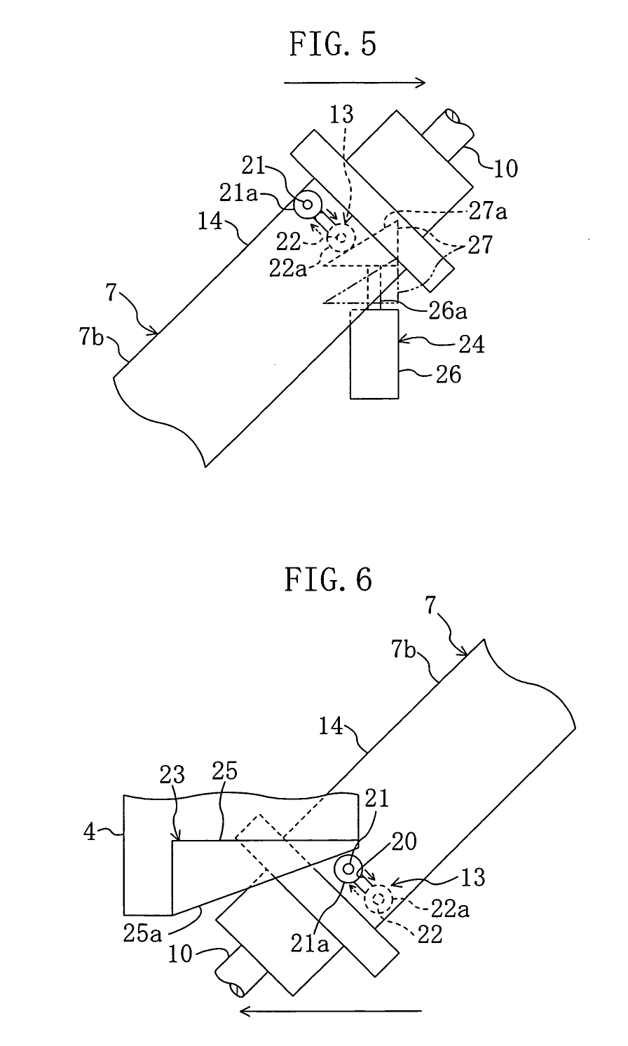

In addition, in the present embodiment, the unlocking means 24 is also formed by an inclined cam 27 having an inclined surface 27a. This inclined cam 27 is fixed to a plunger 26a of an electromagnetic solenoid 26 provided at the holder 4 at a position above the rotator 1. As shown in FIG. 5, with the electromagnetic solenoid 26 magnetized, the inclined cam 27 is located on the path taken by the unlocking actuating lever 22 when it moves; on the other hand, with the electromagnetic solenoid 26 demagnetized, the inclined cam 27 is deviated from the path taken by the actuating lever 22 when it moves. Thus, in the state where the inclined cam 27 is located on the path, taken by the actuating lever 22 when it moves, the unlocking actuating lever 22 of the cylinder 7, which has reached an upper part of the rotator 1 with the rotation thereof, abuts against the inclined surface 27a. As a result, the reversible plate 19 is turned, and thus the locking mechanism 13 is switched to the unlocking position.

It should be noted that the locking means 23 and the unlocking means 24 are not limited to the above-described arrangement, but they may directly move the actuating levers 21, 22 using an electromagnetic solenoid, for example. In that case, it is preferable that the arrival of each of the actuating levers 21, 22 at a predetermined position is detected by a noncontact sensor to operate the electromagnetic solenoid, thus moving the actuating levers 21, 22.

Within the rotator 1, liquid 29 is enclosed. Furthermore, among the eight cylinders 7, a vacuum 28 is formed in one or two of the cylinders 7 located at the upper part of the rotator 1, and the liquid is enclosed in the other cylinders 7.

At a part of the peripheral surface 1a of the rotator 1, a large-diameter liquid inlet 31 is provided. This liquid inlet 31 is provided with an opening/closing valve 30. The liquid inlet 31 is an inlet through which the liquid 29 is supplied to the inside of the rotator 1 and that of each cylinder 7.

Besides, the cylinders 7 (except two of them) are each connected with an inner end of an associated one of connecting pipes 32. The connecting pipe 32 is connected to an uppermost part of the cylinder 7 when it is located at the top part of the rotator 1. A radially extending outer end of each connecting pipe 32 is connected a communicating pipe 33 that has an annular shape with the output shaft 2 centered. The inside of each cylinder 7 is communicated with the communicating pipe 33 via the associated connecting pipe 32.

The annular communicating pipe 33 is communicated with two air vent pipes 35, 35. The air vent pipes 35, 35 are spaced apart by 180° from each other, and are each extended outward in the radial direction of the rotator 1. Each air vent pipe 35 includes an opening/closing valve 34.

At a part of the peripheral surface 1a of the rotator 1 adjacent to each air vent pipe 35, a liquid supply pipe 37 is provided. Each liquid supply pipe 37 is extended outward in the radial direction of the rotator 1, and has an opening/closing valve 36. The length of each of these liquid supply pipes 37 is longer than that of each air vent pipe 35, and when the liquid supply pipe 37 is oriented almost directly above, its opened end is located above that of the air vent pipe 35.

As the liquid 29, mercury, water, heavy water, or any other liquid may be used. In particular, it is preferable to use liquid having a high specific gravity and a low viscosity. In this example, the liquid 29 is water.

In order to enclose the liquid 29 within the rotator 1 such that the vacuum 28 is produced above the base portion 7a of each cylinder 7 located at the upper part of the rotator 1, it is recommended that the liquid 29 is supplied to the inside of the rotator 1 in the following manner.

First, the rotator 1 is stopped such that the liquid inlet 31 is oriented directly above, the opening/closing valve 30 thereof is opened, the opening/closing valve 34 of the air vent pipe 35 adjacent thereto or the opening/closing valve 36 of the liquid supply pipe 37 is opened, and the other valves 34, 35 are closed.

In this state, the supply of liquid starts from the liquid inlet 31, and the valve 30 of the liquid inlet 31 is closed after the inside of the rotator 1 has been substantially filled with the liquid 29. Thereafter, the rotator 1 is slightly rotated such that the air vent pipe 35 adjacent to the liquid inlet 31 and the liquid supply pipe 37 are oriented directly above, and then the rotator 1 is stopped at this position.

Next, the opening/closing valve 34 of the air vent pipe 35 and the opening/closing valve 36 of the liquid supply pipe 37, which are located above, are both opened, and the liquid 29 is injected again through the liquid supply pipe 37. Thus, not only the upper part of the rotator 1, which has not been filled at the first liquid supply, but also the cylinders 7 located thereabove, the connecting pipes 32 and the communicating pipe 33 are surely filled with the liquid 29. At the time when the liquid 29 is overflowed from the air vent pipe 35, the injection of the liquid 29 is stopped, and the valve 34 of the air vent pipe 35 and the valve 36 of the liquid supply pipe 37 are closed.

Thereafter, the valve 36 of the liquid supply pipe 37 located directly below is opened, and the liquid 29 within the rotator 1 is discharged from a lower end thereof such that the liquid level of the liquid 29 corresponds to a liquid level 42 for a liquid level gauge 38 provided across the appropriate range covering from the base portion 7a of the cylinder 7 to a peripheral portion of the rotator 1. Thus, a Torricellian vacuum is produced in the cylinder 7 located at the upper part of the rotator 1.

When the liquid level of the liquid 29 has come down to the position indicated by the reference numeral 42, the valve 36 of the liquid supply pipe 37 located directly below is closed, and thus the liquid level of the liquid 29 is fixed at this position.

In this manner, not only the liquid 29 can be enclosed within the rotator 1, but also the vacuum 28 can be produced in one or two of the cylinders 7 located at the upper part of the rotator 1. This state is defined as an initial state of the apparatus.

In order to produce the vacuum 28 similar to a Torricellian vacuum above the base portion 7a of the cylinder 7 located at the upper part of the rotator 1, the diameter D of the rotator 1 has to be larger than that corresponding to at least 1 atmospheric pressure of the liquid 29. If the liquid 29 is water, the inside diameter D of the rotator 1 has to be larger than 10.34 m, and if the liquid 29 is mercury, the inside diameter D of the rotator 1 has to be larger than 0.76 m. In this example, since the liquid 29 is water, the inside diameter D of the rotator 1 is set at 30 m.

It should be noted that the procedure of enclosing the liquid 29 within the rotator 1 is not limited to the above. For example, the liquid 29 may be injected into the inside of the rotator 1 such that the liquid level of the liquid 29 is at a predetermined position, and the inside of the rotator 1 may be hermetically sealed; then, the air in the cylinder 7 located at the upper part of the rotator 1 may be discharged utilizing a vacuum pump, for example, thereby producing the vacuum 28 in the cylinder 7.

A vacuum gauge 39 is connected to a portion of the communicating pipe 33 via an opening/closing valve 40. This valve 40 is hermetically closed during normal operation. The vacuum gauge 39 detects the degree of vacuum inside the rotator 1 at the time of periodical inspections of the apparatus, for example. To be more specific, the rotator 1 is stopped such that the vacuum gauge 39 is substantially located directly above, and in this state, the measurement value of the vacuum gauge 39 when the opening/closing valve 40 is opened is read. Based on this measurement value, it can be detected whether or not air has penetrated into the rotator 1, each cylinder 7 and the communicating pipe 33 communicated therewith. If the degree of vacuum detected by the vacuum gauge 39 becomes lower than a preset value, or if the liquid level of the liquid 29 detected by the liquid level gauge 38 becomes lower than a preset value due to, e.g., the leakage of the liquid 29 from the rotator 1, the liquid 29 is injected into the inside of the rotator 1 again using the air vent pipe 35 and the liquid supply pipe 37 as described above. Thus, the apparatus is returned to its initial state.

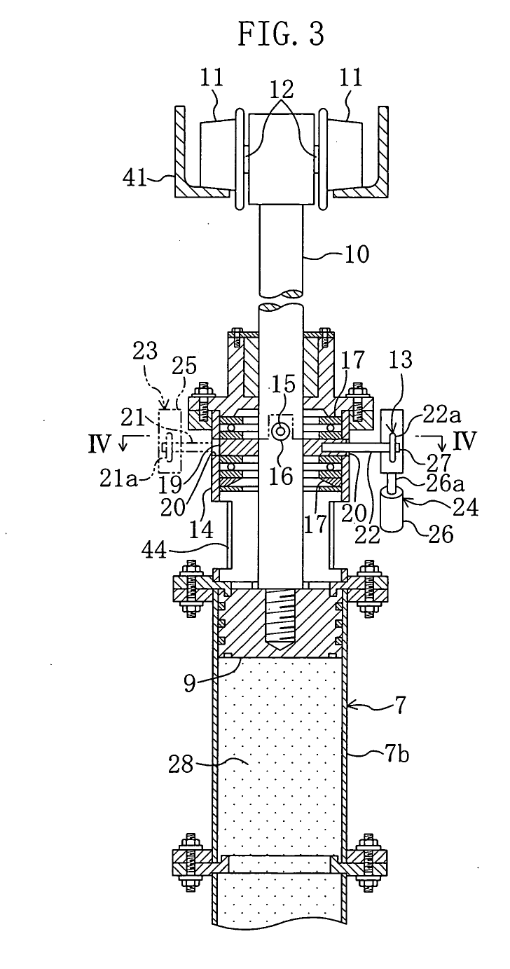

As shown in FIGS. 1 and 3, a guide rail 41 consisting of a pair of members each having an L-shaped cross section is fixed to the holder 4. The guide rail 41 is provided so as to be inclined downward to the right from its starting end, located substantially directly above the rotator 1, to its terminal end. The rollers 11 of the actuator 3 located at the upper part of the rotator 1 are rolled on the guide rail 41. The guide rail 41 is preferably arc-shaped such that a line tangent to each point at the surface, on which the rollers 11 are rolled, constantly forms the same rightward and downward angle of inclination with respect to a straight line perpendicular to a normal line drawn from each point toward the center of the output shaft 2. The length of the guide rail 41 is set to be longer than the range in which the rollers 11 are each turned 45° or more around the output shaft 2. In the shown example, the length of the guide rail 41 is set so that the rollers 11 are each turned approximately 67.5° around the output shaft 2. Since the length of the guide rail 41 and the downward angle of inclination thereof are inversely proportional to each other, the curved shape of the guide rail 41 is set in accordance with the length of the guide rail 41.

Next, the operation of this power generating apparatus will be described. As described above, in the initial state, all the valves 30, 34, 36 and 40 are closed, and the liquid level 42 of the liquid 29 within the rotator 1 and the communicating pipe 33 is set as shown in FIG. 1. In a region of the inside of each cylinder 7 located above the liquid level 42, the vacuum 28 is produced. In FIG. 1, the vacuum 28 is produced in the inside of the cylinder 7 located at the top part of the rotator 1, and in the inside of the cylinder 7 located on the left-hand side of the cylinder 7 at the top part of the rotator 1.

Further, all the actuators 3 are put into the fixed state by the locking mechanism 13.

From this initial state, an initial torque is provided to the rotator 1 by the starter connected to the second gear 6. Thus, the rotator 1 starts rotation. Furthermore, the electromagnetic solenoid 26 of the unlocking means 24 is magnetized so that the inclined cam 27 is positioned on the path taken by the lever 22 when it moves. Thus, with the rotation of the rotator 1, the actuator 3 that has passed through the unlocking means 24 is switched from the fixed state to the movable state. Since the vacuum 28 is produced in the inside of the cylinder 7 of the actuator 3 switched to the movable state, a pressure difference between the inside and outside of the cylinder 7 acts upon the piston 9 thereof. Thus, the piston 9 is retracted into the cylinder 7, and with the ensuing movement of the piston rod 10, the rollers 11 provided at the tips thereof are pressed to the vicinity of the starting end of the guide rail 41. By allowing the rollers 11 to engage with the guide rail 41, the retraction of the piston 9 into the inside of the cylinder 7 is restricted, and instead, the cylinder 7 is moved relative to the piston 9. As a result, a rightward torque is provided to the rotator 1.

With the rotation of the rotator 1, the rollers 11 are rolled along the guide rail 41; however, during this time, the relative movement of the cylinder 7 with respect to the piston 9 is continued until the piston 9 is positioned at the lower end point of the actuating portion 7b. In this manner, the piston 9 is positioned at the lower end point, and the rotation of the rotator 1 causes the actuator 3 to move to a position below the liquid level 42, thereby vanishing the vacuum inside the cylinder 7. At this time point, the rollers 11 reach the terminal end of the guide rail 41, and then the rollers 11 leave the guide rail 41.

The angle at which the rollers 11 of one actuator 3 are rolled on the guide rail 41 is set at approximately 67.5° as already mentioned above, whereas the angle between the adjacent actuators 3 is set at 45°. Therefore, before the rollers 11 of one actuator 3 leave the guide rail 41, the rollers 11 of the next actuator 3 are located on the left end of the guide rail 41. Thus, during the rotation of the rotator 1, the rollers 11 of at least one actuator 3 are always rolled on the guide rail 41, and the above-described similar operation is repeated; therefore, a rightward torque is continuously provided to the rotator 1.

After the rollers 11 of one actuator 3 have left the guide rail 41, the actuator 3 is rotated downward to the right together with the rotator 1, and during this time, the piston 9 is pushed back to the upper end point due to the weight of the liquid 29 inside the rotator 1 and that of the piston 9, piston rod 10 and rollers 11. In other words, by setting a distance H between the liquid level 42 and the piston 9 at 10 m or more, the piston 9 can be pushed back against atmospheric pressure by the weight of the liquid 29 and that of the piston 9, piston rod 10 and rollers 11.

If the actuating lever 21 provided at the actuator 3 has reached the position almost directly below the rotator 1, the roller 21a of the actuating lever 21 runs onto the inclined cam 25 of the locking means 23 provided at this position. Thus, the actuating lever 21 is moved, and the actuator 3 is switched from the movable state to the fixed state.

Thereafter, the actuator 3, which has been switched to the fixed position, is moved upward to the left with the rotation of the rotator 1, and is positioned at the upper part of the rotator 1. Then, if the cylinder 7 exceeds the liquid level 42, the vacuum 28 is gradually produced inside the cylinder 7. During this time, since the actuator 3 is in the fixed state, the piston 9 will not be retracted into the cylinder 7.

Then, the actuator 3 is switched from the fixed state to the movable state by the unlocking means 24, and the rollers 11 of the actuator 3 are engaged with the starting end of the guide rail 41 again. Thereafter, the actuator 3 repeats the above-described similar operation.

If the rotator 1 is placed into a steady rotational state, the starter is stopped. The rotator 1 is rotated at a constant speed by a constant speed device.

When the rotator 1 is stopped, the electromagnetic solenoid 26 of the unlocking mechanism 24 is demagnetized so that the inclined cam 27 is deviated from the path taken by the lever 22 when it moves. Thus, each actuator 3 is not switched to movable state, and no torque is provided to the rotator 1. Consequently, the rotator 1 is stopped.

The rotational power of the rotator 1 is extracted from the output shaft 2 via the first gear 5. This rotational power is obtained by converting the pressure difference between vacuum pressure and atmospheric pressure into torque, and is thus clean so that there is no possibility of environmental pollution whatsoever.

The air, penetrated into each cylinder 7 during the operation of the apparatus, is trapped in the bended portion of the cylinder 7 when the actuator 3 is located in the vicinity of the terminal end of the guide rail 41 (i.e., the air is trapped in the bended portion when the bended portion is located at an upper portion of the cylinder 7), and the air is collected in the communicating pipe 33 via the connecting pipe 32 connected to the bended portion so that the air is trapped in an upper part of the communicating pipe 33.

It should be noted that although each cylinder 7 is formed such that its base portion 7a and actuating portion 7b are bended in the above-described embodiment, the base portion 7a and the actuating portion 7b may each be linearly formed. Although not shown, each cylinder 7, which is linearly formed, may alternatively be provided radially from the peripheral surface of the rotator 1. If each cylinder 7 is radially provided, the guide rail is provided so as to be inclined from its starting end, located above the rotator, to its terminal end located downwardly in the rotational direction of the rotator. Even in such an arrangement, it is possible to convert the pressure difference between vacuum pressure and atmospheric pressure, acting upon the piston 9 of each actuator 3, into the torque of the rotator 1.

In addition, the base portion 7a and the actuating portion 7b do not have to be perpendicular to each other, but may be bended at a predetermined angle. As the angle at which they are bended, an arbitrary angle is adoptable.

Besides, a balance weight, for example, may be utilized as necessary so that the center of gravity of all the rotating members including the rotator 1 corresponds to the center of the output shaft 2.

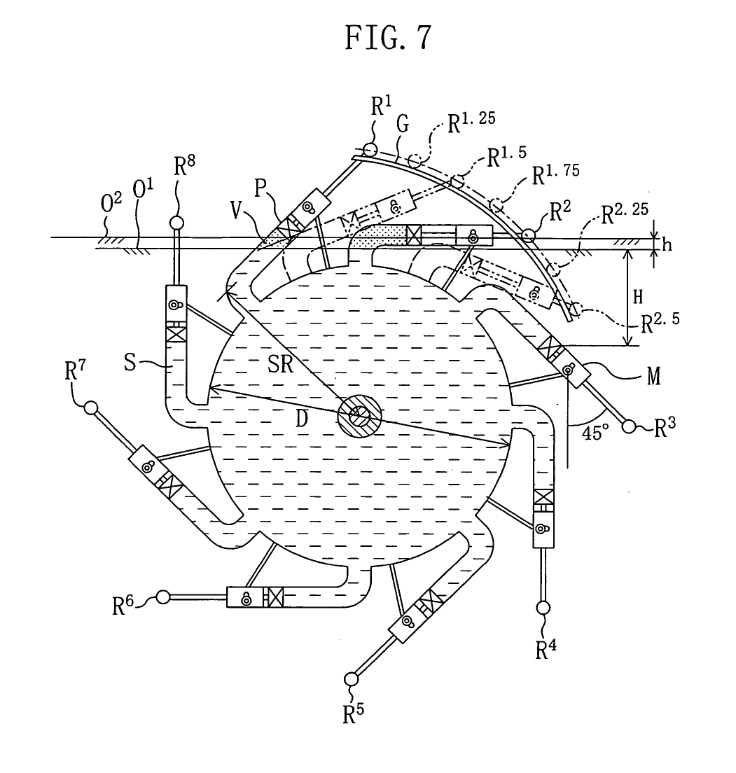

Hereinafter, specific exemplary calculation for the above-described power generating apparatus will be described. FIGS. 7 through 10 are diagrams each illustrating an apparatus formed in the same way as that shown in FIG. 1 and each including reference characters used in calculation. The reference characters in FIGS. 7 through 10 are collectively shown in Table 1.

TABLE 1

| | | | |
|---|---|---|---|
| D | Inside Diameter of | R | Roller |
| | Rotator | | |
| P | Piston | O | Liquid (Water) |
| G | Guide Rail | S | Cylinder |
| V | Vacuum | O¹ -O² | Liquid Level (Water Level) |
| M | Actuator | SR | Radius of Rotation of |
| | | | Actuator |

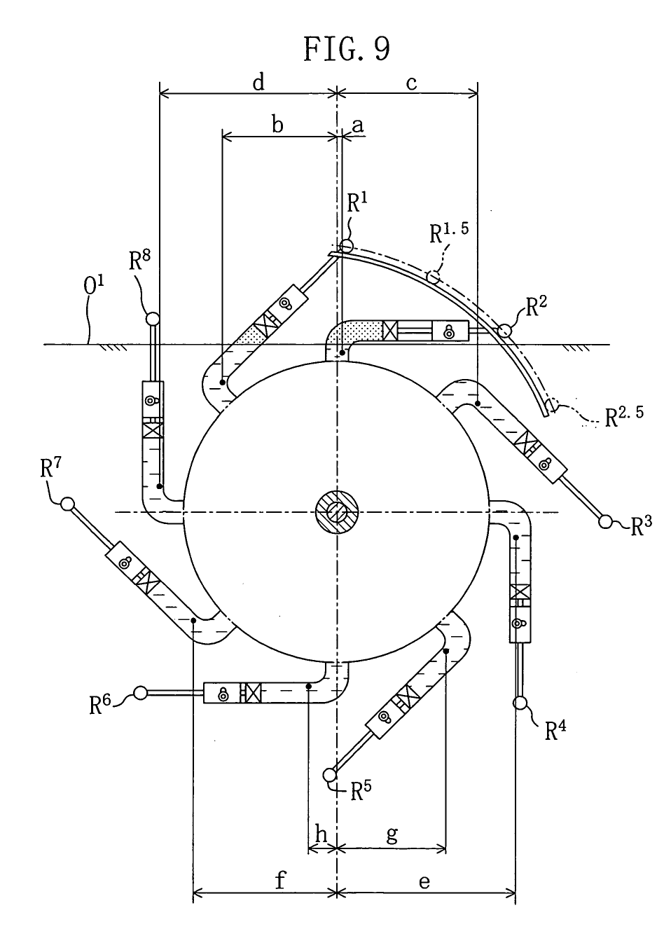

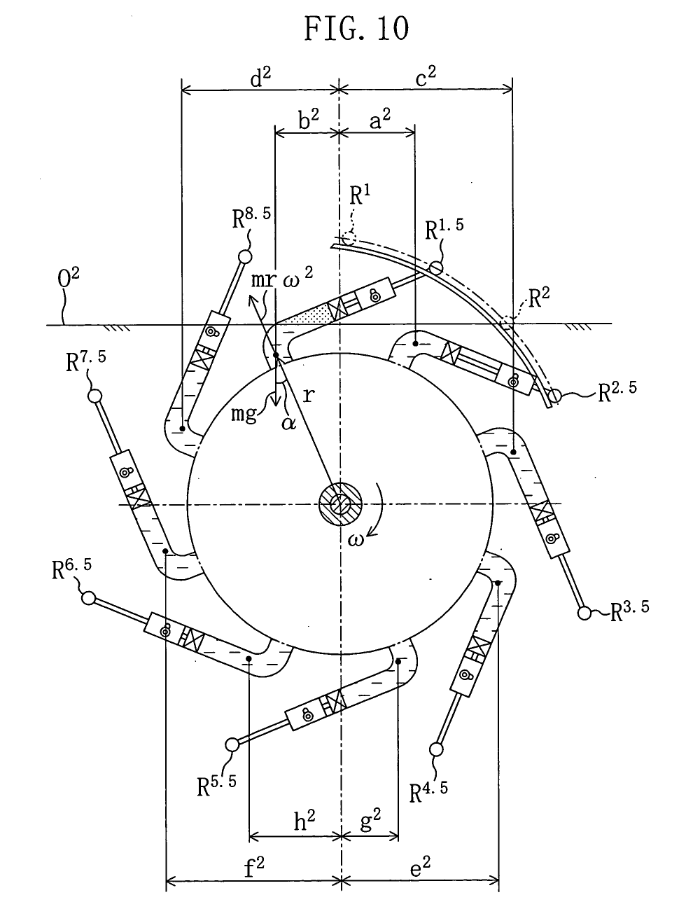

It should be noted that in FIGS. 7 through 10, for the sake of convenience, the rollers located at the starting end of the guide rail, and the actuator including the rollers are represented by R¹, and from there, the respective actuators are represented by R², R³, R⁴, R⁵, R⁶, R⁷, R⁸ in the order of the rotational direction of the rotator. Further, the imaginary lines in FIG. 7 illustrate the state where the rotator is rotated 22.5° from the position indicated by the solid lines in FIG. 7, and FIG. 10 illustrates the state where the rotator is rotated 22.5° from the position shown in FIG. 9; the respective actuators in this state are represented by R^{1.5}, R^{2.5}, R^{3.5}, R^{4.5}, R^{5.5}, R^{6.5}, R^{7.5} and R^{8.5}. Furthermore, R^{1.25} represents the intermediate position between R¹ and R^{1.5}, R^{1.75} represents the intermediate position between R^{1.5} and R², and R^{2.25} represents the intermediate position between R² and R^{2.5}.

1. Data on Apparatus

Hereinafter, data on the apparatus are collectively shown in Table 2.

TABLE 2

| | | | |
|---|---|---|---|
| Rotator | Diameter (Inside Diameter); D | 30 | m |
| | Width of Peripheral Portion | 2.5 | m |
| | Width of Center Portion | 6 | m |
| | Weight | 1506.5 | t |
| | Weight of Liquid (Water) in Rotator | 2410 | t |
| Actuator | Number | 8 | |
| | Weight (Total Weight of Eight Actuators) | 880 | t |
| | Weight of Liquid in Actuators (Total | 211.1 | t |
| | Weight of Liquid in Actuators Except | | |
| | Two of Them Located at Upper Part of | | |
| | Rotator) | | |
| | Weight of Liquid in Actuators (Total | 38.4 | t |
| | Weight of Liquid in Two Actuators Located | | |
| | at Upper Part of Rotator) | | |
| | Radius of Rotation of Actuator; SR | 19 | m |
| Piston | Diameter | 2 | m |
| | Cross-Sectional Area | 3.14 | m² |
| | Stroke | 5 | m |
| Guide Rail | Angle of Inclination; 0 | 70 | |
| Apparatus | Gross Weight | 5046 | t |
| | Total Weight of Piston, Piston Rod and | 15 | t |
| | Rollers of Each Actuator | | |
| | Change in Water Level; h | 0.75 | m |
| | Height from Liquid Level to R³ | 10.5 | m |
| | piston; H | | |

2. Actuation Force of Each Actuator

In the calculation, it is assumed that a complete vacuum is produced in the inside of each cylinder. The actuation force of each actuator, i.e., a force exerted in the axial direction of the cylinder, is generated by atmospheric pressure against the vacuum inside the cylinder. In this embodiment, since the diameter of each piston is 2 m and the cross-sectional area thereof is 3.14 m² as can be seen from Table 2, a force P0 resulting from the atmospheric pressure is calculated using the following Expression 1:

$$P0 = Cross - Sectional Area of Piston \times Atmospheric Pressure \\ = 3.14 ( {m}^{2} ) \times 1.0 \times {10}^{5} ( P a ) = 3.14 \times {10}^{5} ( N ) \qquad ( Expression 1 )$$

Further, assuming that the coefficient of resistance is 0.1, a sliding resistance P2 of the piston is calculated using the following Expression 2:
P2=P0×0.1=(3.14×10⁵)×0.1=3.14×10⁴(N) (Expression 2)

Therefore, an actuation force P3 of one actuator is calculated by subtracting P2 from P0 using the following Expression 3:
P3=P0−P2=3.14×10⁵−3.14×10⁴=2.83×10⁵(N) (Expression 3)
3. Rotation Moment of Rotator

Next, a rotation moment provided to the rotator due to the actuation force of each actuator will be determined. In the present embodiment, with the rotation of the rotator, the apparatus repeats a first state indicated by the solid lines in FIG. 7 and a second state indicated by the imaginary lines in FIG. 7. In the first state, a vacuum is produced in each of the cylinders of the two actuators represented by R¹ and R². On the other hand, in the second state, a vacuum is produced in the cylinder of the actuator represented by R^{1.5}. And a vacuum in the cylinder of the actuator represented by R^{2.5} is vanished.

Therefore, during the transition from the first state to the second state, the actuating forces of two actuators are provided to the rotator; on the other hand, during the transition from the second state to the first state, the actuating force of one actuator is provided to the rotator. Accordingly, using the average of the rotation moment during the transition from the first state to the second state, and the rotation moment during the transition from the second state to the first state, it becomes possible to approximate the rotation moment around the axial center, which is provided to the rotator.

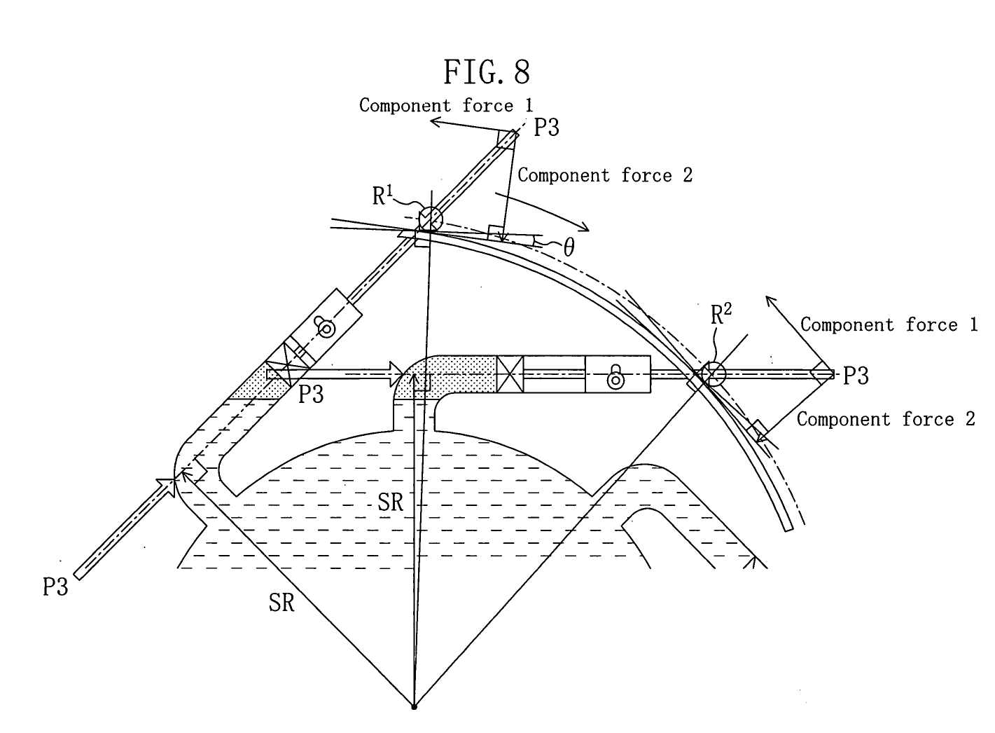

It should be noted that, as shown in FIG. 8, the actuation force P3 of the actuator is not only exerted on the cylinder in the axial direction thereof but also exerted on the rollers and guide rail. Among them, the force P3 exerted on the cylinder is perpendicular to the normal line drawn toward the axial center. Therefore, the force P3 exerted on the cylinder is contributory to the rotation moment of the rotator. On the other hand, the force P3 exerted between the roller and guide rail can be divided into: a component force (component force 1) exerted along the surface of the guide rail on which the rollers are rolled; and another component force (component force 2) exerted in the direction perpendicular to the surface of the guide rail on which the rollers are rolled. A line tangent to each point at the surface of the guide rail, on which the rollers are rolled, has a rightward and downward angle of inclination θ with respect to a straight line perpendicular to a normal line drawn from each point toward the axial center. Therefore, the component force 1 is not perpendicular to the normal line drawn toward the axial center. Consequently, the force P3 exerted between the rollers and guide rail is not contributory to the rotation moment of the rotator.

Accordingly, a rotation moment M0₁ around the axial center, which is provided to the rotator in the first state, is calculated using the following Expression: M0₁=(Rotation Moment Resulting From Actuation Force of R¹)+(Rotation Moment Resulting From Actuation Force of R²)
That is, since the radius of rotation SR of the actuator is 19 m as can be seen from Table 2, the rotation moment M0₁ is calculated using the following Expression 4:

$${M0}_{1} = ( P3 \times SR ) + ( P3 \times SR ) \\ = ( ( 2.83 \times {10}^{5} ) \times 19 ) + ( ( 2.83 \times {10}^{5} ) \times 19 ) \\ = 10.7 \times {10}^{6} ( N \cdot m ) \qquad ( Expression 4 )$$

On the other hand, a rotation moment M0₂ around the axial center, provided to the rotator in the second state, is calculated using the following Expression 5:

$${M0}_{2} = ( Rotation Moment Resulting From Actuation Force of {R}^{1.5} ) \\ = ( P3 \times SR ) \\ = ( ( 2.83 \times {10}^{5} ) \times 19 ) = 5.37 \times {10}^{6} ( N \cdot m ) \qquad ( Expression 5 )$$

Therefore, since a rotation moment M0′ of the rotator is the average of the rotation moment in the first state and the rotation moment in the second state, the rotation moment M0′ is calculated using the following Expression 6:

$${M0}^{′} = ( {M0}_{1} + {M0}_{2} ) / 2 \\ = ( 10.7 \times {10}^{6} + 5.37 \times {10}^{6} ) / 2 \\ = 8.05 \times {10}^{6} ( N \cdot m ) \qquad ( Expression 6 )$$

In this embodiment, supposing that a vacuum efficiency Va is 0.9 and a mechanical efficiency Ma is 0.9, the net rotation moment M0 of the rotator is calculated using the following Expression 7:

$$M0 = {M0}^{′} \times Va \times Ma \\ = ( 8.05 \times {10}^{6} ) \times 0.9 \times 0.9 = 6.52 \times {10}^{6} ( N \cdot m ) \qquad ( Expression 7 )$$

4. Rotation Resistance of Rotator

A rotation resistance moment Md of the rotator associated with the output shaft will be determined.

As can be seen from Table 2, the gross weight of the apparatus is 5046 (t)=5.046×10⁵ (N), while the radius of the output shaft is 1 (m); therefore, supposing that the resistance coefficient of the output shaft is 0.007, the rotation resistance moment Md is calculated using the following Expression 8:

$$Md = Gross Weight \times Radius of Output Shaft \times Resistance Coefficient \\ = ( 5046 \times {10}^{5} ) \times 1 \times 0.007 \\ = 3.53 \times {10}^{5} ( N \cdot m ) \qquad ( Expression 8 )$$

5. Weight Balance of Apparatus

In the apparatus, among the eight actuators protruding from the peripheral surface of the rotator, the pistons are not positioned at the upper end points in the two actuators located at the upper part of the rotator, and therefore, the weight of the liquid in each cylinder of these two actuators differs from that of the liquid in each of the other cylinders. Thus, the rotation moment resulting from a difference between the liquid weights acts upon the rotator. In this embodiment, the rotation moment around the axial center, generated due to the weight balance in the first state, and the rotation moment around the axial center, generated due to the weight balance in the second state, are calculated, and then the average of these rotation moments is defined as the rotation moment around the axial center due to the weight balance.

First, with reference to FIG. 9, the weight balance in the first state will be calculated. The respective reference characters a, b, c, d, e, f, g and h in FIG. 9 each signify a horizontal distance between the axial center and the center of gravity of the liquid in each actuator. The moments around the axial center due to the weight of the liquid in each actuator are collectively shown in Table 3.

In this embodiment, the weight of liquid in the actuators (R¹, R⁸, R⁷, R⁶) located on the left-hand side of the axial center becomes a rotation moment in the negative direction with respect to the rotational direction of the rotator, while the weight of liquid in the actuators (R², R³, R⁴, R⁵) located on the right-hand side of the axial center becomes a rotation moment in the positive direction with respect to the rotational direction of the rotator.

TABLE 3

| | Weight | Distance | Moment | | Weight | Distance | Moment |
|---|---|---|---|---|---|---|---|
| | (N) | (m) | (N · m) | | (N) | (m) | (N · m) |
| R¹ | 2.9 × 10⁵ | 11 (b) | 3.19 × 10⁶ | R² | 9.40 × 10⁴ | 0.45 (a) | 4.23 × 10⁴ |
| R⁸ | 3.52 × 10⁵ | 18.25 (d) | 6.42 × 10⁶ | R³ | 3.52 × 10⁵ | 15.2 (c) | 5.35 × 10⁶ |
| R⁷ | 3.52 × 10⁵ | 15.2 (f) | 5.35 × 10⁶ | R⁴ | 3.52 × 10⁵ | 18.3 (e) | 6.42 × 10⁶ |
| R⁶ | 3.52 × 10⁵ | 3.2 (h) | 1.13 × 10⁶ | R⁵ | 3.52 × 10⁵ | 10.6 (g) | 3.73 × 10⁶ |

| | | | |
|---|---|---|---|
| Total on Left-Hand Side; | 1.61 × 10⁷ | Total on Right-Hand Side; | 1.55 × 10⁷ |
| Md₁¹ (L) | | Md₁¹ (R) | |

Therefore, a rotation moment Md₁¹ provided to the rotator in the first state is calculated using the following Expression 9:

$${Md}_{1}^{1} = ( - ) {Md}_{1}^{1} ( L ) + {Md}_{1}^{1} ( R ) \\ = ( - ) 1.61 \times {10}^{7} + 1.55 \times {10}^{7} \\ = ( - ) 5.43 \times {10}^{5} ( N \cdot m ) \qquad ( Expression 9 )$$

Next, with reference to FIG. 10, the weight balance in the second state will be calculated.

The respective reference characters a², b², c², d², e², f², g² and h² in FIG. 10 each signify a horizontal distance between the axial center and the center of gravity of liquid in each actuator. The moments around the axial center due to the weight of the liquid in each actuator are shown in Table 4.

Also in the second state, the weight of liquid in the actuators (R^{1.5}, R^{8.5}, R^{7.5}, R^{6.5}) located on the left-hand side of the axial center becomes a rotation moment in the negative direction with respect to the rotational direction of the rotator, while the weight of liquid in the actuators (R^{2.5}, R^{3.5}, R^{4.5}, R^{5.5}) located on the right-hand side of the axial center becomes a rotation moment in the positive direction with respect to the rotational direction of the rotator.

TABLE 4

| | Weight | Distance | Moment | | Weight | Distance | Moment |
|---|---|---|---|---|---|---|---|
| | (N) | (m) | (N · m) | | (N) | (m) | (N · m) |
| R^{1.5} | 1.8 × 10⁵ | 5.95 (b²) | 1.12 × 10⁶ | R^{2.5} | 1.96 × 10⁴ | 7.6 (a²) | 1.49 × 10⁶ |
| R^{8.5} | 3.52 × 10⁵ | 15.65 (d²) | 5.51 × 10⁶ | R^{3.5} | 3.52 × 10⁵ | 18.1 (c²) | 6.37 × 10⁶ |
| R^{7.5} | 3.52 × 10⁵ | 18.1 (f²) | 6.37 × 10⁶ | R^{4.5} | 3.52 × 10⁵ | 15.65 (e²) | 5.51 × 10⁶ |
| R^{6.5} | 3.52 × 10⁵ | 9.95 (h²) | 3.50 × 10⁶ | R^{5.5} | 3.52 × 10⁵ | 4 (g²) | 1.41 × 10⁶ |

| | | | |
|---|---|---|---|
| Total on Left-Hand Side; | 1.65 × 10⁷ | Total on Right-Hand Side; | 1.48 × 10⁷ |
| Md₁² (L) | | Md₁² (R) | |

Therefore, a rotation moment Md₁² provided to the rotator in the second state is calculated using the following Expression 10:

$${Md}_{1}^{2} = ( - ) {Md}_{1}^{2} ( L ) + {Md}_{1}^{2} ( R ) \\ = ( - ) 1.65 \times {10}^{7} + 1.48 \times {10}^{7} \\ = ( - ) 1.72 \times {10}^{6} ( N \cdot m ) \qquad ( Expression 10 )$$

Accordingly, the moment Md₁ around the axial center due to the weight balance is calculated as the average of the rotation moment Md₁¹ in the first state and the rotation moment Md₁² in the second state by using the following Expression 11:

$${Md}_{1} = ( {Md}_{1}^{1} + {Md}_{1}^{2} ) / 2 \\ = ( 5.43 \times {10}^{5} + 1.72 \times {10}^{6} ) / 2 \\ = ( - ) 1.13 \times {10}^{6} ( N \cdot m ) \qquad ( Expression 11 )$$

6. Effective Rotation Moment of Rotator

From the above calculation results, an effective rotation moment MT of the rotator is calculated using the following Expression 12:

$$MT = M0 - ( Md + {Md}_{1} ) \\ = 6.52 \times {10}^{6} - ( 0.353 \times {10}^{6} + 1.13 \times {10}^{6} ) \\ = 5.04 \times {10}^{6} ( N \cdot m ) \qquad ( Expression 12 )$$

7. Confirmation of Centrifugal Force

In the apparatus, since the rotator has a large diameter of about 30 m, a relatively large centrifugal force acts upon the liquid in each actuator. Therefore, the relationship between the weight of liquid in the two actuators located at the upper part of the rotator, and a centrifugal force that acts upon the liquid is confirmed, thus setting an upper limit for the number of rotations of the apparatus. In this case, it is assumed that the mass of the liquid in the actuators is concentrated on its center of gravity, and the centrifugal force acts upon the position of the center of gravity. As shown in FIG. 10, if the angle formed by the line connecting the center of gravity of the liquid to the axial center of the rotator, and the associated plumb line is α, the following expression: “Centrifugal Force”<“Liquid Weight×cos α” has to be satisfied in order to make the centrifugal force smaller than the liquid weight. Accordingly, the following expression holds true:
(m·rω²)<(m·g·cos α)
where m is a mass of the liquid, r is a distance between the center of gravity of the liquid and the axial center of the rotator, (ω is an angular speed of the rotator, and g is a gravitational acceleration.

From the above expression, the angular speed of the rotator has to satisfy the following Expression 13:
ω<(g·cos α/r)^{1/2} (Expression 13)

Therefore, as for R^{1.5}, the following Expressions: r=17.58 (m), cos α=0.34 hold true, and thus the following expression:
ω<(9.8×0.34/17.58)^{1/2}=0.434 (rad/sec)=4.15 rpm
is derived from Expression 13.

Furthermore, as for R^{2.5}, the following Expressions: r=17.71 (m), cos α=0.43 hold true, and thus the following expression:
ω<(9.8×0.43/17.71)^{1/2}=0.487 (rad/sec)=4.65 rpm
is derived from Expression 13.

Consequently, the upper limit for the number of rotations in the apparatus is preferably 4 rpm.

8. Output of Apparatus

From the above, an output PW of the apparatus will be calculated. In this case, the output PW (unit W; watt) is calculated using the following Expression 14:
PW=MT×2π×Number of Rotations(rpm)/60 (Expression 14)

Therefore, from Expression 14, an output PW_{1.5} when the number of rotations is 1.5 rpm is calculated as follows:
PW_{1.5}=5.04×10⁶×2π×1.5/60=791 (kW)

Similarly, an output PW₂ when the number of rotations is 2 rpm, an output PW₃ when the number of rotations is 3 rpm, and an output PW₄ when the number of rotations is 4 rpm are calculated as follows:
PW₂=5.04×10⁶×2π×2/60=1055 (kW)
PW₃=5.04×10⁶×2π×3/60=1583 (kW)
PW₄=5.04×10⁶×2π×4/60=2110 (kW)
9. Supplementary Description

In the apparatus, when the rollers are rolled on the guide rail, the piston of the actuator moves to the lower end point, and after the rollers have left the guide rail, the piston returns to the upper end point due to the weight of the liquid and the weight of the piston, piston rod and rollers. Hereinafter, this return of the piston will be confirmed.

In order to allow the piston to be pushed back, since the axis of the cylinder is downwardly extended at the position indicated by R³ after the rollers have left the guide rail, it is sufficient that the magnitude of a force for pushing the piston into the cylinder due to atmospheric pressure is compared with that of a force for pushing back the piston due to the liquid weight and the total weight of the piston, piston rod and rollers.

The total weight of the piston, piston rod and rollers of each actuator is calculated using the following expression: 15(t)=1.5×10⁵ (N) as can be seen from Table 2. Further, in FIG. 7, since the axis of the cylinder at the position indicated by R³ has an angle of 45° with respect to a downwardly extending plumb line associated thereto, a component force F1, which is resulting from the total weight of the piston, piston rod and rollers and is exerted in the axial direction of the cylinder, is calculated using the following Expression 15:
F₁=(1.5×10⁵)×sin (45°)=1.06×10⁵(N) (Expression 15)

Furthermore, a height H from the liquid level to the piston associated with R³ is 10.5 m (see FIG. 7 and Table 2), and the cross-sectional area of the piston is 3.14 ml; therefore, a force F₂ for pushing back the piston due to the weight of liquid (water) is calculated using the following Expression 16:
F₂=3.14(m²)×10.5(m)×1000 (kg/m³)×10 (m/sec²)=3.30×10⁵(N) (Expression 16)

On the other hand, a force F₃ for pushing the piston into the cylinder due to atmospheric pressure is calculated using the following Expression 17:
F₃=3.14(m²)×1.0×10⁵ (Pa)=3.14×10⁵(N) (Expression 17)

From Expressions 15 through 17, the following expression: F₁+F₂>F₃ holds true. Therefore, at the position indicated by R³ after the rollers have left the guide rail, the piston is pushed back to the upper end point of the cylinder due to the weight of the liquid and the total weight of the piston, piston rod and rollers.

As described above, in the present invention, the pressure difference between vacuum pressure and atmospheric pressure can be converted into the torque of the rotator so that energy source is not only clean but also limitless, and furthermore, stable supply is ensured. Therefore, the inventive power generating apparatus is useful for driving an electric generator, for example.

1. A power generating apparatus for generating power utilizing a pressure difference between vacuum pressure and atmospheric pressure, the apparatus comprising:
a holder;
a rotator which is rotatably supported with respect to the holder so as to be rotated in one direction around a horizontal axis, and in which liquid is enclosed;
two or more actuators provided at equal intervals around the periphery of the rotator; and
a guide rail provided so as to be inclined from its starting end, located above the rotator, to its terminal end located downwardly in a rotational direction of the rotator,
wherein each of the actuators has:
a cylinder that is provided at the periphery of the rotator and is communicated with the inside of the rotator;
a piston that is inserted into the cylinder and is reciprocated in an axial direction of the cylinder between an upper end point and a lower end point thereof;
a piston rod connected to the piston;
a roller that is attached to a tip of the piston rod and is rolled on the guide rail; and
a locking mechanism for switching each of the actuators between a fixed state in which the piston is fixed at the upper end point so that the reciprocation of the piston is restricted, and a movable state in which the reciprocation of the piston is allowed,
wherein the liquid is enclosed in the inside of the rotator and that of each cylinder such that a liquid level is formed within the cylinder of at least one of the actuators located at an upper part of the rotator, and a state in which a vacuum is produced above the liquid level within the cylinder is defined as an initial state, and
wherein the apparatus rotates the rotator by allowing the plurality of actuators to sequentially repeat:
a first step in which the actuator, whose cylinder has a vacuum produced therein, is switched to the movable state by the locking mechanism, and the piston located at the upper end point of the cylinder is retracted into the cylinder utilizing a pressure difference between vacuum pressure and atmospheric pressure;
a second step in which the roller of the actuator switched to the movable state is engaged with a part of the guide rail in the vicinity of the starting end thereof;
a third step in which due to the engagement of the roller with the guide rail, the cylinder of the actuator is moved relative to the piston, and torque is provided to the rotator;
a fourth step in which the relative movement of the cylinder is continued, and with the ensuing rotation of the rotator, the roller is rolled on the guide rail;
a fifth step in which upon arrival of the roller at the terminal end of the guide rail, the piston is located at the lower end point of the cylinder, and furthermore, the cylinder is located below the liquid level, thus vanishing the vacuum within the cylinder;
a sixth step in which after the roller has left the terminal end of the guide rail, the piston is moved to the upper end point of the cylinder due to the weight of the liquid and the weight of the piston, piston rod and roller;
a seventh step in which the actuator, whose piston has moved to the upper end point, is switched to the fixed state by the locking mechanism; and
an eighth step in which the actuator switched to the fixed state is moved above the liquid level with the rotation of the rotator, and a vacuum is produced again within the cylinder of the actuator.

2. The power generating apparatus according to claim 1,
wherein the cylinder of each of the actuators comprises: a base portion protruded in a radial direction from the peripheral surface of the rotator; and an actuating portion that is bended at an outer end of the base portion and is extended in the rotational direction of the rotator, and
wherein the piston is reciprocated within the actuating portion.

3. The power generating apparatus according to claim 1,
wherein the cylinder of each of the actuators is protruded linearly in a radial direction from the peripheral surface of the rotator.

4. The power generating apparatus according to claim 1,
wherein the apparatus further comprises: an air vent pipe communicated with the cylinder of at least one of the actuators; and a liquid supply pipe provided in the vicinity of the air vent pipe at the peripheral surface of the rotator, and
wherein an opened end of the liquid supply pipe is located above that of the air vent pipe when the opened end of the liquid supply pipe is located at a top part of the rotator.

5. The power generating apparatus according to claim 1,
wherein the locking mechanism has an actuating lever, and
wherein the apparatus further comprises:
unlocking means, provided in the vicinity of the upper part of the rotator, for operating the actuating lever so as to switch the actuator from the fixed state to the movable state; and
locking means, provided in the vicinity of a lower part of the rotator, for operating the actuating lever so as to switch the actuator from the movable state to the fixed state.

6. The power generating apparatus according to claim 1,
wherein the apparatus further comprises a starter for providing an initial torque to the rotator.

7. The power generating apparatus according to claim 1,
wherein the apparatus further comprises a constant speed device for keeping the rotational speed of the rotator at a constant speed.
